(19) United States
(12) Patent Application Publication
(10) Pub. No.: US 2026/0192523 A1
(43) Pub. Date: Jul. 9, 2026

(54) Device for generation of a three-dimensional object that encodes data by additive manufacturing

(71) Applicant: INSTITUT NATIONAL DE RECHERCHE EN INFORMATIQUE ET EN AUTOMATIQUE, Le Chesnay (FR)

(72) Inventors: Sylvain LEFEBVRE, Le Chesnay (FR); Samuel KENZARI, Le Chesnay (FR)

(21) Appl. No.: 19/124,010

(22) PCT Filed: Oct. 20, 2023
(86) PCT No.: PCT/EP2023/079350

§ 371 Date: Apr. 24, 2025

(30) Foreign Application Priority Data
Oct. 28, 2022 (FR) FR2211305

(51) Int. Cl. B29C 64/386; B33Y 50/00; B33Y 80/00

(52) U.S. Cl. CPC B29C 64/386; B33Y 50/00; B33Y 80/00

(57) ABSTRACT

A device for generating a three-dimensional object that encodes data by additive manufacturing. The device includes: a memory arranged to receive information data to be encoded and object substrate data having shape data and encoding-type data; an encoder designed to determine a set of target lengths and a number of layers on the basis of the information data to be encoded and of the encoding-type data; an initializer designed to initialize a three-dimensional object model from the shape data with a stack of layers corresponding to the number of layers in an additive manufacturing production direction, thereby defining an object surface, to define on the object surface a number of measurement points corresponding to the number of lengths in the set of target lengths, and to generate paths between pairs of measurement points, each path matching a length from the set of target lengths.

### CROSS-REFERENCE TO RELATED APPLICATIONS

This Application is a Section 371 National Stage Application of International Application No. PCT/EP2023/079350, filed Oct. 20, 2023, and published as WO 2024/088914 A1 on May 2, 2024, not in English, which claims priority to and the benefit of French Patent Application No. 2211305, filed Oct. 28, 2022, the contents of which are incorporated herein by reference in their entireties.

### FIELD OF THE DISCLOSURE

The invention relates to the field of manufacturing objects that encode information and in particular objects produced by additive manufacturing that encode information.

### BACKGROUND

The field of objects that encode information is currently relatively undeveloped. Information encoding is generally performed by affixing a sign on the surface, such as a bar code or a QR code.

Certain developments have attempted to provide anti-counterfeit objects, such as application FR3098758 which relates to a marking in an authentication volume by scanning by X-ray diffractometry, XRD.

None of these systems are satisfactory. Indeed, surface codes are limited, whereas marking in an authentication volume is complex to implement and scanning by X-ray diffractometer, XRD does not allow wide scattering.

### SUMMARY

The invention improves the situation. To this end, it relates to a device for the generation of a three-dimensional object that encodes data by additive manufacturing, comprising a memory arranged to receive information data to be encoded and object substrate data comprising shape data and encoding-type data, an encoder arranged to determine a set of target lengths and a number of layers on the basis of the information data to be encoded and of the encoding-type data, an initialiser arranged to initialise a three-dimensional object model from the shape data with a stack of layers corresponding to said number of layers in an additive manufacturing production direction, thereby defining an object surface, to define on the object surface a number of measurement points corresponding to the number of lengths in the set of target lengths, and to generate paths between pairs of measurement points, each path matching a length from the set of target lengths, each measurement point being associated with a unique path, the length of each path being less than or equal to the target length with which it is associated, a path being defined by a continuous sequence of movements of fixed dimension between the measurement points associated with this path, each movement being expressed along one of three directions associated with a three-dimensional point of reference, one of which matches the additive manufacturing production direction, each movement defining a space inside the stack of layers making it possible to measure a physical property characterising a measurement associated with the path to which this movement belongs, and a computer arranged to modify the movements of the paths generated by the initialiser so that the latter each have a length matching the target length with which they are associated, by applying a stochastic optimisation, of which the operations are exclusively the addition, deletion or modification of one or more movements, said operations furthermore having to preserve the continuity of each path, the inclusion of each path within the stack of layers, and prevent overlapping or adjacency of two paths with each other.

This device is particularly advantageous because it makes it possible to encode information in the object body in a manner that is secure and easy to recover.

According to various embodiments, the invention may have one or more of the following features:
the computer is furthermore arranged to apply a stochastic optimisation such that the paths associated with a non-zero target length have an identical number of operations along the additive manufacturing production direction,
the computer is furthermore arranged to apply a stochastic optimisation such that the paths associated with a non-zero target length have a monotonic direction of travel of the stack layers,
the computer is arranged to apply a stochastic optimisation of which the operations increase the Manhattan distance between the space defined by the movements subject to a modification and the space defined by the paths which are closest to it according to the Manhattan distance,
the encoder is arranged to define a surface code on an upper portion of the object surface, and
the encoder is arranged to define a random or pseudo-random set of target lengths, and to return a value matching the measurement associated with the paths.

The invention also relates to a method for generating a three-dimensional object that encodes data by additive manufacturing, comprising the following operations:
a) receiving information data to be encoded and object substrate data comprising shape data and encoding-type data,
b) determining a set of target lengths and a number of layers on the basis of the information data to be encoded and of the encoding-type data,
c) initialising a three-dimensional object model from the shape data with a stack of layers corresponding to said number of layers in an additive manufacturing production direction, thereby defining an object surface, defining on the object surface a number of measurement points corresponding to the number of lengths in the set of target lengths, and generating paths between pairs of measurement points, each path matching a length from the set of target lengths, each measurement point being associated with a unique path, the length of each path being less than or equal to the target length with which it is associated, a path being defined by a continuous sequence of movements of fixed dimension between the measurement points associated with this path, each movement being expressed along one of three directions associated with a three-dimensional point of reference, one of which matches the additive manufacturing production direction, each movement defining a space within the stack of layers making it possible to measure a physical property characterising a measurement associated with the path to which this movement belongs, and
d) modifying the movements of the paths generated by operation c) so that the latter each have a length matching the target length with which they are associated, by applying a stochastic optimisation, of which the operations are exclusively the addition, deletion or modification of one or more movements, said operations furthermore having to preserve the continuity of each path, the inclusion of each path within the stack of layers, and prevent overlapping or adjacency of two paths with each other.

According to various embodiments, this method may have one or more of the following features:
operation d) comprises applying a stochastic optimisation such that the paths associated with a non-zero target length have an identical number of operations along the additive manufacturing production direction,
operation d) comprises applying a stochastic optimisation such that the paths associated with a non-zero target length have a monotonic direction of travel of the stack layers,
operation d) comprises applying a stochastic optimisation of which the operations increase the Manhattan distance between the space defined by the movements subject to a modification and the space defined by the paths which are closest to it according to the Manhattan distance,
operation b) comprises defining a surface code on an upper portion of the object surface, and
operation b) comprises defining a random or pseudo-random set of target lengths, and to return a value matching the measurement associated with the paths.

The invention also relates to a computer program comprising instructions for executing the method according to the invention, a data storage medium wherein such a computer program is saved and a computer program comprising a processor coupled with a memory, the memory having saved such a computer program.

### BRIEF DESCRIPTION OF THE DRAWINGS

Other features and advantages of the invention will become more apparent upon reading the following description, taken by way of illustrative and non-limiting examples, taken from drawings wherein:

FIG. 1 shows a schematic diagram of a device according to the invention,

FIG. 2 shows an example of an operating loop of the device of FIG. 1,

FIG. 3 shows an example of a function implemented by the encoder of FIG. 1, and

FIG. 4 shows an example of a function implemented by the initialiser of FIG. 1.

### DETAILED DESCRIPTION OF ILLUSTRATIVE EMBODIMENTS

The drawings and the following description essentially contain elements of certain nature. Hence, they could not only be used to better understand the present invention but also contribute to the definition thereof, where appropriate.

The present description is likely to involve elements subject to protection by royalties and/or copyright. The holder of the rights has no objection to the identical reproduction by whomsoever of the present patent document or its description, as it appears in the official records. For the rest, it wholly reserves its rights.

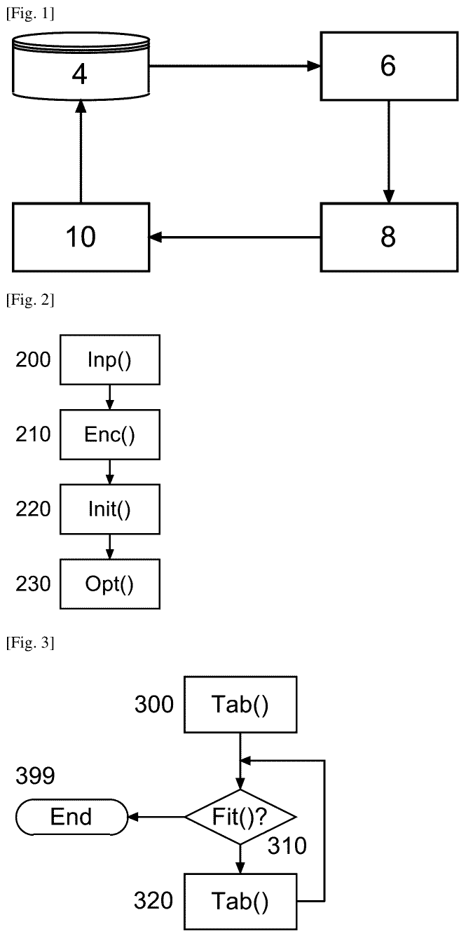

FIG. 1 shows a schematic diagram of a device for generation of a three-dimensional object that encodes data by additive manufacturing 2 according to the invention.

The device 2 has the role of receiving data defining one or more messages to be encoded in a three-dimensional object as an input, and returning an additive manufacturing model of this object making it possible, by a measurement of a physical quantity, to recover the one or more messages. As a general rule, the one or more messages can contain any type of information, whether it has a meaning or not.

The device 2 comprises a memory 4, an encoder 6, an initialiser 8 and a computer 10.

The memory 4 can be any type of data storage capable of receiving digital data: hard drive, flash solid-state drive, flash memory in any form, random access memory, magnetic disk, storage distributed locally or in the cloud, etc.

In the example described here, the memory 4 receives all the data relating to the device 2, i.e. the programs and software instantiating the encoder 6, the initialiser 8 and the computer 10, the parameters and hyperparameters thereof, the weights of the neural networks where applicable, the outputs and intermediate data of the neural networks, the data received as an input, the intermediate values, the data stored in buffer memory, as well as the output additive manufacturing model data. The data computed by the device can be stored in any type of memory similar to the memory 4, or therein. These data can be deleted after the device has performed its tasks or retained.

In the example described here, the memory 4 receives information data to be encoded as well as object substrate data as input data. The object substrate data contain shape data as well as encoding-type data.

The object substrate data make it possible to define how that information data to be encoded will be used to generate the additive manufacturing model. Indeed, the Applicant has discovered that its invention makes it possible to generate a very wide variety of objects that encode information in diverse manners.

Thus, these objects can comprise a surface code and a code in the object body which are mutually independent. In this case, the code in the object body can be used as a steganographic tag, which makes possible to authenticate the object uniquely, regardless of the surface code. In another variant, these codes can follow on from each other, i.e. the surface code forms most significant (or least significant) bits, whereas the code in the object body forms least significant (or most significant) bits. Also alternatively, the surface code and the code in the object body can be complementary and form a public key/private key pair. Finally, the surface code (or the code in the object body) can serve as a public key to be combined with an unknown private key to make it possible to decode a message (payload) contained in the code in the object body (or in the surface code).

The encoding-type data make it possible to define the selected paradigm and determine the message to be encoded in the code in the object body, and therefore its additive manufacturing model.

Indeed, the Applicant has discovered that additive manufacturing thanks to its precision and novel material possibilities makes it possible to encode very complex information while offering an easy manner to read it.

Thus, an object can comprise on one face a plurality of measurement points, optionally connected to a plurality of measurement points on another face (for example the opposite face in the additive manufacturing direction). As a general rule, the measurement points can be distributed on the surface of the additive manufacturing model, and the measurement points can be associated pairwise, such that each pair of points represents a power of two, or a position in a code which has a base value. Furthermore, the length of the path between two points can also be measured to modulate the base value. Thus, if the points are connected together by an electrically conductive element, a measurement at the terminals of the two measurement points can make it possible to determine the resistance of the path connecting them and therefore its length to extract a value. Alternatively, the paths can be hollow, and the measurement can be the measurement of the flow time of a fluid from one measurement point to the other. Also alternatively, a thermal conduction phenomenon can be used to measure the length of the path between two measurement points, etc. Thus, it is possible to encode a very long message in the object body, and read this message by a simple measurement of a physical property.

The shape data make it possible, for their part, to define the general shape of the object for which it is sought to generate the additive manufacturing model. Thus, it can be of cubic or parallelepipedal shape, which are the most spontaneous shapes, but more generally, the invention allows any shape: with hexahedral base, of variable cross-section, etc. Typically, the shape data can be viewed as a set of staked layers that match a sought shape for the object before the code is integrated in its body. The shape data can indicate portions of these layers that must be retained and must not be associated with a path.

Thus, the information data to be encoded and the object substrate data constrain the additive manufacturing model. Indeed, according to the complexity of the message to be encoded, how this message is encoded and the specific shape sought for the object, it will be possible to produce the additive manufacturing model directly, or it will be necessary to modify the shape data, for example by adding layers or by modifying the scale of the object to make it possible to implement the paths that encode the code in the object body.

As will be seen hereinafter, for this, the device 2 uses, on one hand, the encoder 6 in order to pre-dimension the additive manufacturing model of the object, followed by the initialiser 8 in order to prepare the work of the computer 10. Finally, the computer 10 performs a stochastic optimisation in order to define paths in the object body which make it possible to comply with the composition rules thereof, both from the point of view of its structural integrity and from the point of view of subsequent measurement making it possible to recover the code in the object body.

This stochastic approach is particularly advantageous because it makes it possible to free the design constraints and is particularly adapted to additive manufacturing. Indeed, the stochastic approach ensures that, if a satisfactory solution exists (i.e. a set of paths for which the lengths comply with the optimisation and manufacturing tolerances), it will be found, and additive manufacturing, by means of the freedom on dimensioning, makes it possible to ensure that a solution exists regardless of the shape of the object or the size of the message to be encoded.

Thus, the additive manufacturing model produced by the device 2 will comprise layer data defining each layer of the object. These layer data will be distributed on a grid matching the envisaged additive manufacturing, and will define at each point or cell of the grid whether this point is empty or filled and the material with which it is filled. To obtain this final result, the encoder 6 starts from the information data to be encoded and the object substrate data to create a set of initial layer data that match a ‘filled’ object capable of receiving the paths required to encode the code in the object body. It is obvious that a ‘filled’ object can include hollowed zones as long as it is still possible to manufacture it by additive manufacturing, or have zones wherein the material density is lower than in the rest of the object. The encoder 6 also has the function of generating a table of target lengths which will define the length to be taken by each path between two measurement points in order to encode the information data to be encoded. As explained hereinabove, these lengths are determined on the basis of the physical property measurement envisaged, such that the measurement of this property is directly linked to this length and makes it possible to define a value associated with a pair of measurement points.

The initial layer data are then transmitted to the initialiser 8 which will define, on one hand, the locations of the measurement points on the surface of the object (for example on opposite faces, or otherwise), and, on the other, which will initialise paths between pairs of measurement points on the basis of the table of target lengths.

Then, the computer 10 optimises the paths generated by the initialiser 8 in order to comply with the shape constraints of the object defined by the shape data, obtain paths for which the lengths match the target length table, and comply with the structural manufacturing and property measurement constraints.

All the data described above may be stored in the memory 4.

The encoder 6, the initialiser 8 and the computer 10 access the memory 4 directly or indirectly. They can be embodied in the form of an appropriate computer program executed on one or more processors. Processors should be understood as any processor adapted to the computations described hereinafter. Such a processor can be embodied in any known manner, in the form of a microprocessor for a personal computer, laptop, tablet or smartphone, a dedicated FPGA or SoC type chip, a computing resource on a grid or in the cloud, a cluster of graphic processors (GPUs), a microcontroller, or any other shape capable of supplying the computing power required for the embodiment described hereinabove. One or more of these elements can also be embodied in the form of application-specific electronic circuits such as an ASIC. A combination of processor and electronic circuits can also be envisaged. Dedicated machine learning processors may also be envisaged.

FIG. 2 shows an example of an operating loop of the device 2.

In an operation 200, the device 2 executes a function Inp( ). The function Inp( ) makes it possible to receive the input data with a view to generating the additive manufacturing model. As seen hereinabove, the input data comprise the information data to be encoded and the object substrate data. The input data can be obtained by any means, using a human-machine interface and by accessing it in the memory 4 or in any other storage.

Then, the encoder 6 executes a function Enc( ) in an operation 210. As described hereinabove, the function Enc( ) has the role of converting the information data to be encoded into a table of target lengths on the basis of the encoding-type data. Furthermore, the function Enc( ) has a further role of instantiating the filled layers defining the object to receive the code in its body.

FIG. 3 shows an implementation of the function Enc( ).

In an operation 300, the encoder 6 accesses the information data to be encoded and the encoding-type data and executes a function Tab( ) which returns a table containing the target lengths of the paths. The encoding-type data play a particular role. Indeed, on the basis of the physical property measured to determine the length of the paths as well as the encoding type selected (table with N bits, word comprising N groups of words with K bits each, random value), the function Tab( ) creates a separate table of target lengths. As will be seen hereinafter, the measurement of the length of the paths can be directly correlated with the physical length of the paths, but it can also be based on other properties, such as on the number of bends comprised in a path, the property measurement being provided to make it possible to count them.

Then, a function Fit( ) is executed in an operation 310. The function Fit( ) uses as arguments, on one hand, the shape data, and, on the other, the table of target lengths. The function Fit( ) has the role of verifying whether it is possible to produce paths for which the lengths are contained in a table of target lengths within the object defined by the shape data. This verification can be carried out by means of machine learning training (for example based on a boosted tree) or be based on analytical criteria (for example the fact that the object is not higher than the shortest path length when the measurement points are disposed on respectively top and bottom faces of the object).

If the function Fit( ) returns a positive value, then the function Enc( ) is stopped in an operation 399. Otherwise, a function Adapt( ) is executed in an operation 320 and the operation 310 is repeated. The function Adapt( ) can determine alone if it is necessary to increase or decrease the size of the additive manufacturing model, or use a return value of the function Fit( ). The function Adapt( ) proceeds in the example described here by reducing or increasing the shape data by a scale factor.

Once the function Enc( ) of the operation 210 has been completed, a function Init( ) is executed by the initialiser 8 in an operation 220.

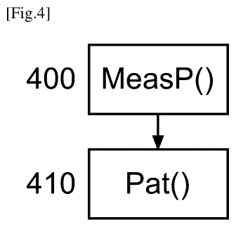

FIG. 4 shows an implementation of the function Init( ).

As explained hereinabove, the function Init( ) starts from the shape data optionally modified by the function Enc( ) and the table of target lengths and has the role generating the measurement points on the surface of the object, and initialising paths between each pair of measurement points.

Thus, in an operation 400, a function MeasP( ) disposes measurement points randomly or pseudo-randomly on the surface of the object. The function MeasP( ) can also be constrained by surface code provided on one of the faces, such that the measurement points can be forced as belonging to a part of the surface code (for example a lighter part) or to the other (for example a darker part). Furthermore, the function MeasP( ) creates the pairs of measurement points to be connected by paths. The pairs of measurement points generated by the function MeasP( ) are unique in the example described here, and a measurement point is only connected to a unique other measurement point.

In one particular variant, connection points may be created inside the object body in order to make it possible to create triplets, quadruplets or more measurement points connected to each other. In this case, these multiple connections may be used either to make the analysis of the object more difficult (because it is necessary to know which pair of points is relevant or whether it consists of a combination of the two measurements), or to encode more information.

Subsequently, in an operation 410, a function Pat( ) receives as arguments the table of target lengths and the set of measurement points generated by the function MeasP( ) of the operation 400. The function Pat( ) proceeds by determining paths between the measurement points of each pair matching the lengths of the table of target lengths as well as possible.

For example, the function Pat( ) can apply a Djykstra type algorithm to determine the shortest path between each pair of measurement points, and associate with each pair of points one of the lengths of the table of target lengths in order of increasing length of each path. Thus, each pair of measurement points finds itself associated with a part of the message of the information data to be encoded.

Alternatively, the function Pat( ) can apply the algorithm described in the article by Lefebvre et al. ‘Information texture synthesis’, 2021, hal-01706539, accessible at the address https://web.archive.org/web/20221019215343/https://hal.inria.fr/hal-01706539v4.

Optionally, after the execution of the function Pat( ) (or at the end thereof), the initialiser 8 can ‘freeze’ a part of the paths so that the computer 10 does not modify them. For example, the visible part of the paths may have been constructed with a secondary aim, such as following a logo, encoding information, etc. It is obvious that this will require that the frozen part be shorter than the target length associated with the path concerned. This is particularly advantageous when the ‘Information texture synthesis’ algorithm is used to generate a visible part of the paths: the initialiser 8 can then freeze the visible part according to the method of the article ‘Information texture synthesis’ encoding an item of visual information in the pattern formed by the paths, and generate the rest at random.

Preferably but optionally, the operation 410 can validate that none of the initialised paths is longer than the length with which it is associated. This makes it possible to prevent a risk of non-convergence of the next operation. When this is the case, the operations 400 and 410 can be repeated until this condition is fulfilled.

Once the function Init( ) of the operation 220 has been completed, a function Opt( ) is executed by the computer 10 in an operation 230.

As explained hereinabove, this function has the role optimising the paths from the operation 220 until all the paths have a length matching the length associated with them in the table of target lengths following the operation 400.

The function Opt( ) implements a stochastic optimisation algorithm. More specifically, it consists of a ‘Simulated Annealing’ type algorithm as described in the article by Kirkpatrick et al. ‘Optimization by Simulated Annealing’, Science 1983. Alternatively, other stochastic algorithms may be applied, for example alternatively the genetic algorithms described in the article ‘Genetic Algorithms in Search, Optimization, and Machine Learning’, Goldberg, 1989.

For this, this algorithm modifies each path pseudo-randomly. For this, in each path, a sub-sequence of this path of randomly chosen size will undergo a modification operation. The type of operation will be chosen in a weighted pseudo-random manner on the basis of the distance between the length of path to which this sub-sequence belongs and the length with which it is associated in the table of target lengths.

As seen hereinabove, each layer is represented on a grid of which x and y are two orthogonal axes, and z is the layer stacking direction during additive manufacturing. Thus, each path can be seen as a sequence of unitary movements along x, y or z. The operations performed on each sub-sequence may therefore be:
an expansion operation, by adding a sequence (+1;−1) in x, y, or z around the sub-sequence, an operation,
a reduction operation, by deleting two movements of opposite sign in x, y or z in the sub-sequence, or
a mixing operation, by pseudo-random organisation of a sequence of movement within the sub-sequence.

Each time one of these operations is carried out, the operation Opt( ) is arranged to verify that the change induced does not cause structural problems (impossible to construct the additive manufacturing model), or measurement problems (intersection or overlapping of two paths following the operation). The verification also implies validating that the operation does not induce any movements of type (+1;−1) or conversely in x, y or z, because this would have no physical consequence in the object. If this is the case, then the operation is rejected. Otherwise, the optimisation loop resumes with a new path, and a new sub-sequence to be modified.

Optionally and preferably, the function Opt( ) can furthermore implement one or more of the following rules:
the movements in z must be monotonic, i.e. there are only movements in +z or in-z. From an upper layer receiving all the measurement points, this makes it possible to ensure that all the paths have the same number of layer transitions. This is particularly advantageous when the measurement of the length of the paths is based on the measurement of the electrical resistance thereof. Indeed, the transitions between two layers, which hence form the movements in z, can have more fluctuating resistances than in x or in y. Consequently, by ensuring the same number of movements in z, the measurement noise is substantially the same for all the paths.
the verification that the operation makes it possible to decrease the proximity of the paths with each other, it being possible to define this proximity as the Manhattan distance for each movement of the sub-sequence concerned by the current optimisation operation and its closest neighbour in another path. If the proximity of the modified sub-sequence is greater than that of the initial sub-sequence, then the operation can be cancelled and another sub-sequence modification operation be executed, until the proximity between neighbours increases.

Optionally, the function Opt( ) can furthermore implement one or more of the following rules:
the movements in z observe a bitonic sequence (path that ‘goes up then down’ or ‘goes down then up’)
the movements in z have the same number of upward/downward movements without a set order.

Although in the example described here, the grid of the layers has square elements, it may have tetrahedral elements or any other shape. Furthermore, when a length of the table of target lengths is zero, the function Opt( ) can be arranged either to produce no path, or to produce discontinuous pieces of paths from one, the other or both of the measurement points concerned.

Thus, the device 2 makes it possible to produce a considerable variety of objects by additive manufacturing, the applications of which are extremely varied:
production of a surface code, or not,
production of an authenticity code by encoding a random value in the object body,
production of a public key/private key code, or shared secret, etc.

These embodiments, while being extremely simplified by the use of a paradigm based on stochastic algorithms, make use of simple physical property measurements such as the measurement of resistance, temperature or flow time of a fluid or a gas, which renders the deployment of these objects extremely simple.

Although the present disclosure has been described with reference to one or more examples, workers skilled in the art will recognize that changes may be made in form and detail without departing from the scope of the disclosure and/or the appended claims.

1. A device for generating a three-dimensional object that encodes data by additive manufacturing, comprising:
at least one processor;
at least one non-transitory computer readable medium comprising instructions stored thereon which when executed by the at least one processor configure the device to:
receive information data to be encoded and object substrate data comprising shape data and encoding-type data;
determine a set of target lengths and a number of layers on the basis of the information data to be encoded and of the encoding-type data;
initialise a three-dimensional object model from the shape data with a stack of layers corresponding to said number of layers in an additive manufacturing production direction, thereby defining an object surface, to define on the object surface a number of measurement points corresponding to a number of lengths in the set of target lengths, and to generate paths between pairs of measurement points, each path matching a length from the set of target lengths, each measurement point being associated with a unique path, the length of each path being less than or equal to the target length with which said path is associated, each path being defined by a continuous sequence of movements of fixed dimension between the measurement points associated with said path, each movement being expressed along one of three directions associated with a three-dimensional point of reference, one of which matches the additive manufacturing production direction, each movement defining a space inside the stack of layers making it possible to measure a physical property characterising a measurement associated with the path to which said movement belongs; and
modify the movements of the paths generated each have a length matching the target length with which the paths are associated, by applying a stochastic optimisation, of which operations are exclusively an addition, a deletion or a modification of one or more movements, said operations furthermore having to preserve a continuity of each path, an inclusion of each path within the stack of layers, and prevent overlapping or adjacency of two paths with each other.

2. The device according to claim 1, wherein the instructions further configure the device to apply a stochastic optimisation such that the paths associated with a non-zero target length have an identical number of operations along the additive manufacturing production direction.

3. The device according to claim 1, or wherein the instructions further configure the device to apply a stochastic optimisation such that the paths associated with a non-zero target length have a monotonic direction of travel of the stack layers.

4. The device according to claim 1, wherein the instructions further configure the device to apply a stochastic optimisation of which the operations increase the Manhattan distance between a space defined by the movements subject to a modification and a space defined by the paths which are closest to it according to the Manhattan distance.

5. The device according to claim 1, wherein the instructions further configure the device to define a surface code on an upper portion of the object surface.

6. The device according to claim 1, wherein the instructions further configure the device to define a random or pseudo-random set of target lengths, and to return a value matching the measurement associated with the paths.

7. A method for generating a three-dimensional object that encodes data by additive manufacturing, the method being performed by a device and comprising the following operations:
a) receiving information data to be encoded and object substrate data comprising shape data and encoding-type data,
b) determining a set of target lengths and a number of layers on the basis of the information data to be encoded and of the encoding-type data,
c) initialising a three-dimensional object model from the shape data with a stack of layers corresponding to said number of layers in an additive manufacturing production direction, thereby defining an object surface, defining on the object surface a number of measurement points corresponding to a number of lengths in the set of target lengths, and generating paths between pairs of measurement points, each path matching a length from the set of target lengths, each measurement point being associated with a unique path, the length of each path being less than or equal to the target length with which said path is associated, each path being defined by a continuous sequence of movements of fixed dimension between the measurement points associated with said path, each movement being expressed along one of three directions associated with a three-dimensional point of reference, one of which matches the additive manufacturing production direction, each movement defining a space within the stack of layers making it possible to measure a physical property characterising a measurement associated with the path to which said movement belongs, and
d) modifying the movements of the paths generated by operation c) so that each have a length matching the target length with which the paths are associated, by applying a stochastic optimisation, of which operations are exclusively an addition, a deletion or a modification of one or more movements, said operations furthermore having to preserve a continuity of each path, an inclusion of each path within the stack of layers, and prevent overlapping or adjacency of two paths with each other.

8. The method according to claim 7, wherein operation d) comprises applying a stochastic optimisation such that the paths associated with a non-zero target length have an identical number of operations along the additive manufacturing production direction.

9. The method according to claim 8, wherein operation d) comprises applying a stochastic optimisation such that the paths associated with a non-zero target length have a monotonic direction of travel of the stack layers.

10. The method according to claim Z, wherein operation d) comprises applying a stochastic optimisation of which the operations increase the Manhattan distance between a space defined by the movements subject to a modification and a space defined by the paths which are closest to it according to the Manhattan distance.

11. The method according to claim 7, wherein operation b) comprises defining a surface code on an upper portion of the object surface.

12. The method according to claim 7, wherein operation b) comprises defining a random or pseudo-random set of target lengths, and returning a value matching the measurement associated with the paths.
